(19) United States
(12) Patent Application Publication
(10) Pub. No.: US 2024/0038464 A1
(43) Pub. Date: Feb. 1, 2024

(54) PUSHBUTTON SWITCH

(71) Applicant: NKK SWITCHES CO., LTD., Kawasaki-shi, Kanagawa (JP)

(72) Inventors: Yotaro OKANO, Kawasaki-shi, Kanagawa (JP); Masahiro AOYAMA, Kawasaki-shi, Kanagawa (JP); Nobuhiko BETSUDA, Kawasaki-shi, Kanagawa (JP)

(21) Appl. No.: 18/019,524

(22) PCT Filed: Jul. 28, 2021
(86) PCT No.: PCT/JP2021/027892

§ 371 Date: Feb. 3, 2023

(30) Foreign Application Priority Data
Aug. 5, 2020 (JP) 2020-132922

(51) Int. Cl. H01H 13/83

(52) U.S. Cl. CPC H01H 13/83; H01H 2219/066; H01H 2217/032

(57) ABSTRACT

The invention addresses the problem of providing a pushbutton switch which can give a clear operation feeling to a person who performs a push operation, and in which the sharpness, accuracy, and brightness of an image output from a display can be increased as compared with those in the related art. A button accepts a pressing operation. Lenses focus and project an image output from a display on a diffuser plate on the top surface of the button 1. A holding member holds the lenses. Further, the holding member is configured of a combination of a spacer having a rib fitted to a rib receiver of the lens arranged on the top surface side among the lenses 15a to 15d, a spacer having a rib receiver fitted to a part of the lens arranged on the external display side, and an aperture film sandwiched between the spacer and the spacer. As a result, the above problem is resolved.

### TECHNICAL FIELD

The present invention relates to a pushbutton switch.

### BACKGROUND ART

Conventionally, there has been a human-machine interface (input device), in which a plurality of pushbutton switches having an image display function are arranged on a display. Such a human-machine interface has begun to be employed in the field of broadcast audio equipment. The human-machine interface as such must ensure brightness of an image displayed on pushbutton switches. As one of the techniques to ensure brightness of an image displayed on pushbutton switches, a known technique shortens the distance between an image display unit of a pushbutton switch and a display (for example, see Japanese Unexamined Patent Application, Publication No. 2015-84313). However, by shortening the distance between the image display unit of the pushbutton switch and the display, the stroke of a depressing operation on the pushbutton switch will be shortened as well. As a result, a person who performs a depressing operation on the pushbutton switch cannot obtain a clear operational feeling; in line with this, another technique mounts lenses or optical members inside the switch, thereby projecting an image from the display onto the pushbutton switch (for example, see Japanese Unexamined Patent Application, Publication No. H06-44857). However, although some conventional techniques including those in Patent Documents 1 and 2 may be able to ensure a sufficient stroke, the lens configuration as described above cannot correct aberrations, resulting in a distorted image, and cannot provide clear and accurate display. In addition, due to a limit in the aberration correction, the total length of the lenses may be prolonged or the F value of the lenses (a value calculated by dividing the focal length of a lens by an effective aperture) may be increased, which may result in a dark image. For these reasons, there is a technical problem in ensuring sharpness, accuracy, and brightness of the image displayed in the image display unit of a pushbutton switch, as well as an operational feeling experienced by a person who performs a depressing operation. To cope with this situation, the present applicant previously filed an invention of a pushbutton switch that is able to display an image outputted from a display with increased sharpness, accuracy, and brightness as compared to conventional examples and is also able to give a clear operational feeling to a person who performs a depressing operation (PCT/JP2020/003555, description and drawings).
Patent Document 1: Japanese Unexamined Patent Application, Publication No. 2015-84313
Patent Document 2: Japanese Unexamined Patent Application, Publication No. H6-44857
Patent Document 3: PCT/JP2020/003555, description and drawings

### DISCLOSURE OF THE INVENTION

### Problems to be Solved by the Invention

In the relevant technical field, however, there is a demand for development of a technique that makes it possible to display an image outputted from a display with further increased sharpness, accuracy, and brightness, as compared to conventional examples.

The present invention has been made against such a background, and an object of the present invention is to provide a pushbutton switch that is able to give a clear operational feeling to a person who performs a depressing operation and is also able to display an image outputted from a display with further increased sharpness, accuracy, and brightness, as compared to conventional examples.

### Means for Solving the Problems

In order to achieve the above-mentioned object, the pushbutton switch according to the present invention includes:
a transparent or substantially transparent button that receives a depressing operation and is arranged above an external display;
a plurality of lenses arranged between the button and the external display, the plurality of lenses projecting an image outputted from the external display as focused on a top panel of the button in a standby position before performing the depressing operation; and
a retaining member that retains the plurality of lenses such that a position and orientation of each of the plurality of lenses are fixed relative to the external display, wherein
the retaining member is configured with a combination including a first retaining member that has a first fitted part to be fitted with a first projection part or a first recessed part provided in a vicinity of an edge part of one of the plurality of lenses arranged adjacent to the top panel; a second retaining member that has a second fitted part to be fitted with a second projection part or a second recessed part provided in a vicinity of an edge part of one of the plurality of lenses arranged adjacent to the external display; and a diaphragm member sandwiched between the first retaining member and the second retaining member.

### Effects of the Invention

According to the present invention, it is possible to provide a pushbutton switch with which a person who performs the depressing operation is able to obtain a clear operational feeling and which is also able to display the image outputted from the display with further increased sharpness, accuracy, and brightness, as compared to conventional examples.

### BRIEF DESCRIPTION OF THE DRAWINGS

FIG. 1 is a perspective appearance view of a pushbutton switch according to an embodiment of the present invention.

FIG. 2 is a perspective cross-sectional view of the pushbutton switch in FIG. 1.

FIG. 3A is a plan appearance view of the pushbutton switch in FIG. 1.

FIG. 3B is a bottom appearance view of the pushbutton switch in FIG. 1.

FIG. 3C is a front appearance view of the pushbutton switch in FIG. 1.

FIG. 3D is a side appearance view of the pushbutton switch in FIG. 1.

FIG. 4A is a front appearance view of a lens unit constituting the pushbutton switch in FIG. 1.

FIG. 4B is a perspective appearance view of the lens unit constituting the pushbutton switch in FIG. 1.

FIG. 4C is an exploded view of the lens unit constituting the pushbutton switch in FIG. 1.

FIG. 5 is a cross-sectional view of a pushbutton switch previously filed by the present applicant.

FIG. 6A is a conceptual drawing indicating brightness of light passing through a pushbutton switch using a lens barrel.

FIG. 6B is a conceptual drawing indicating brightness of light passing through the pushbutton switch in FIG. 1.

### PREFERRED MODE FOR CARRYING OUT THE INVENTION

Referring to the drawings, a pushbutton switch 1 according to an embodiment of the present invention will be described. Note that the present invention is not limited to the following embodiments. Further, in the present disclosure, phrases expressing “up/above/top” such as “upper side”, “top face”, and “upward direction” denote the direction toward the top panel side (the operator side) of the pushbutton switch 1. On the contrary, phrases expressing “down/below/bottom” such as “lower side”, “bottom face”, and “downward direction” denote the direction toward where the display is disposed.

### [Basic Configuration]

The pushbutton switch 1 according to the present embodiment is a pushbutton switch that can display a video outputted from a display D, via a transparent or substantially transparent mounting panel P arranged above the display D, on a top panel of a button 11 in a standby position before performing a depressing operation. The video outputted from the display D includes a still image and a moving image. The pushbutton switch 1 can display either a still image or a moving image outputted from the display D, on the top panel of the button 11 in a standby position before performing a depressing operation.

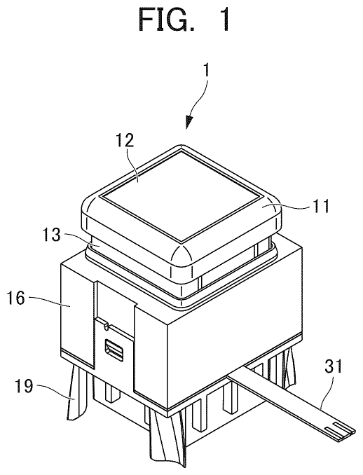

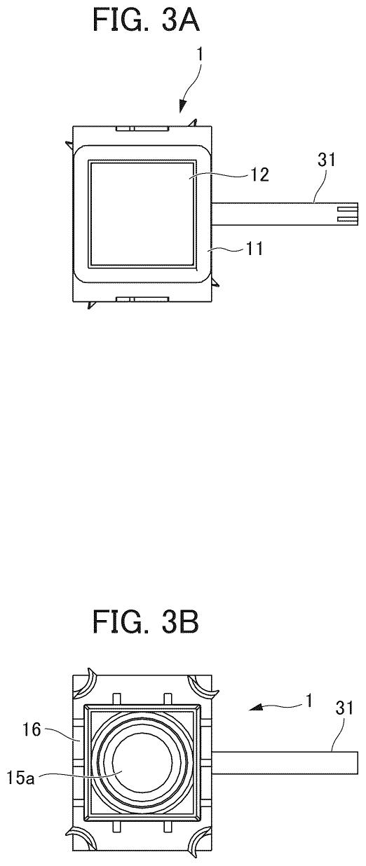

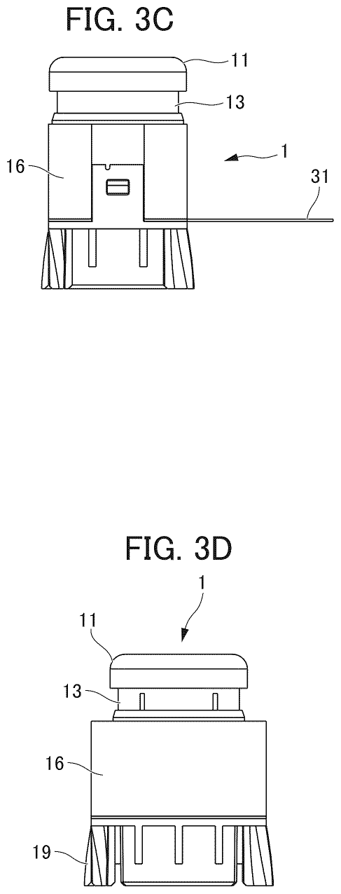

As illustrated in FIG. 1 to FIG. 3C, the pushbutton switch 1 as such is configured to include a button 11, a diffuser plate 12, a plunger 13, a retaining member 14, four lenses 15a, 15b, 15c and 15d, a housing 16, a coil spring 17, a contact point 18, and a fixing plate 19.

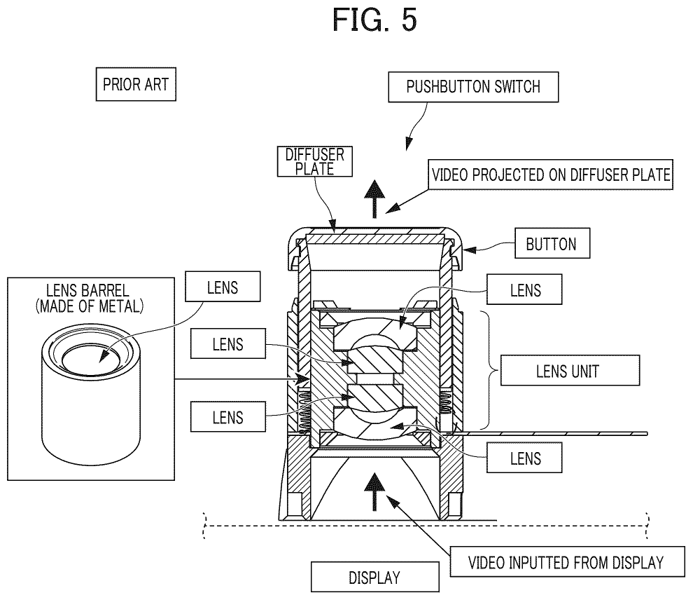

In an existing pushbutton switch, as illustrated in FIG. 5 for example, in the state before performing a depressing operation on a button, a video outputted from a display is inputted in the direction of the arrow and displayed on a diffuser plate. Specifically, as illustrated in FIG. 5, a light ray group of the video displayed on the display is inputted in the direction of the arrow, refracted and condensed as passing through a lens unit including a lens barrel and the four lenses arranged in the lens barrel, and formed as an inverted image focused on the diffuser plate. As a result, the video displayed on the display is rotated 180 degrees as a video projected onto the diffuser plate.

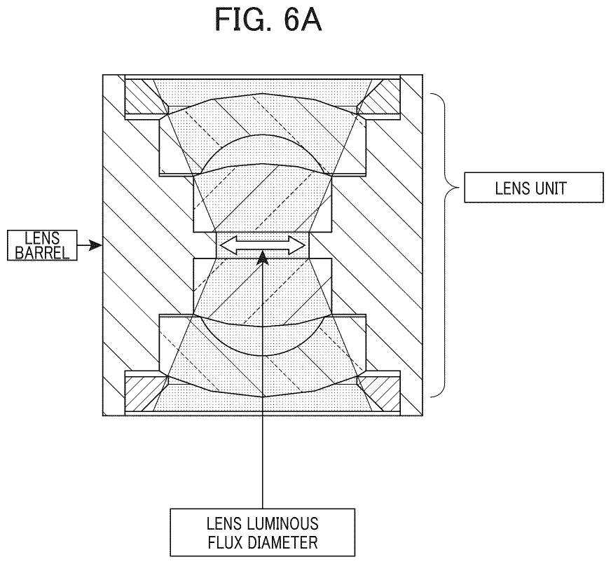

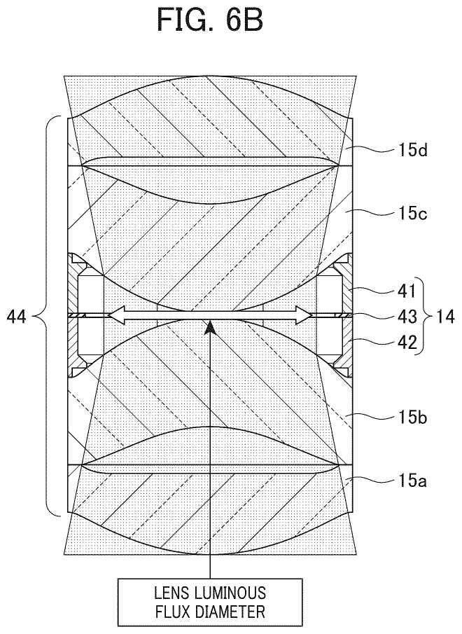

In other words, when a conventional method is used for the configuration illustrated in FIG. 5, the lens barrel made of metal and constituting the lens unit incorporates two lenses arranged on the display side or adjacent to the display and two lenses arranged on the diffuser plate side or adjacent to the diffuser plate, so as to align the positions of the lenses and to adjust the focal point. Specifically, the lens barrel made of metal determines a passage for the light ray group, and the inputted light ray group is condensed and diffused by providing a stepped structure in such a manner that the diameters of the lenses arranged in an upper end part and a lower end part of the lens unit are larger than the diameters of the two lenses arranged in a central part of the lens unit. However, the conventional method by which the lenses are incorporated in the lens barrel, as illustrated in FIG. 6A, has a small luminous flux diameter, which represents brightness. A problem thus arises where the video displayed on the diffuser plate is darkened. In addition, there is a demand for further shortening the total length of the lenses, while ensuring that the video is focused.

In view of the above, as illustrated in FIG. 6B, the present embodiment does not employ the lens barrel used in the conventional method. Instead, a retaining member 14 including a combination of spacers (spacers 41 and 42) that are made of resin and have light-blocking characteristics and a diaphragm film 43 aligns the positions of the lenses and adjusts the focal point. In other words, in the present embodiment, the inputted light ray group is condensed and diffused by a lens unit 44 including: lenses 15a to 15d each having a convex surface and a concave surface or flat surface; and the retaining member 14 that retains the lenses by using ribs and rib receptacles to be described later. In this configuration, as illustrated in FIG. 6B, because the lens luminous flux diameter, which represents brightness is larger, the video displayed on the diffuser plate is brighter. Specific configurations of the lenses 15a to 15d and the retaining member 14 used in the present embodiment will be described later.

### [Specific Configuration]

Hereinafter, each constituent element of the pushbutton switch 1 according to the present embodiment will be described in detail.

### (Button)

The button 11 is a button that receives a depressing operation on the pushbutton switch 1 and is arranged at the top of the pushbutton switch 1, as illustrated in FIG. 1 to FIG. 3C. When a depressing operation on the button 11 is performed, the button 11, the diffuser plate 12, and the plunger 13 move in the direction of the depressing operation, in conjunction with the depressing operation. Along with these movements, the coil spring 17 contracts in the direction of the depressing operation. Then, at the contact point 18, the blocked state is switched to the energized state, or the energized state is switched to the blocked state. Although the shape of the button 11 is not limited in particular, in the present embodiment, the shape is a substantially square pole shape having four rounded corners and a flat portion on the top panel, as illustrated in FIG. 1 to FIG. 3C.

### (Diffuser Plate)

The diffuser plate 12 is a transparent or substantially transparent diffuser plate that functions as a screen for projecting light of a video; and specifically, the diffuser plate 12 diffuses the light of the video incident thereon and emits the light. The diffuser plate 12 is arranged on the top panel of the button 11. Therefore, a video projected onto the diffuser plate 12 can be easily visually recognized by a person who intends to depress the pushbutton switch 1. Although the shape of the diffuser plate 12 is not limited in particular, in the present embodiment, the shape is a square or substantially square shape as illustrated in FIG. 1, for example. The diffuser plate 12 and the button 11 may be integrally formed, by using a diffuser plate material of the diffuser plate 12 as a button material of the button 11.

### (Plunger)

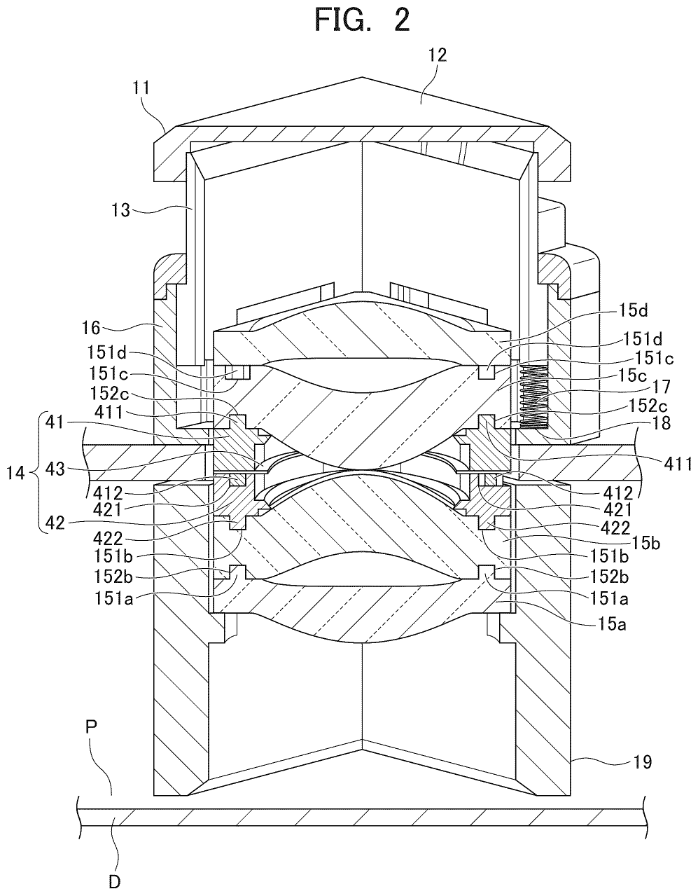

The plunger 13 is arranged as coupled to the bottom of the button 11. When a depressing operation on the button 11 is performed, the plunger 13 slides downward in conjunction with the depressing operation. An upper end part of the coil spring 17 is connected to the bottom of the plunger 13. Therefore, when the plunger 13 slides downward, the coil spring 17 contracts in the direction of the depressing operation, in conjunction therewith. Although the shape of the plunger 13 is not limited in particular, in the present embodiment, the shape is a substantially square pole shape having a cavity inside, as illustrated in FIGS. 1 and 2, for example. The lens unit 44 including the retaining member 14 and the lenses 15a to 15d is arranged in the cavity inside the plunger 13.

### (Retaining Member)

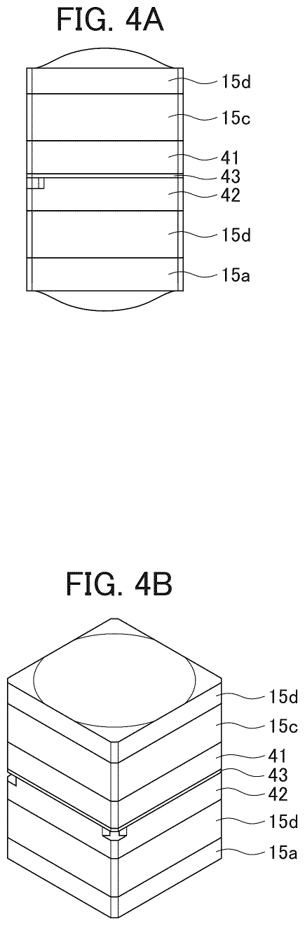

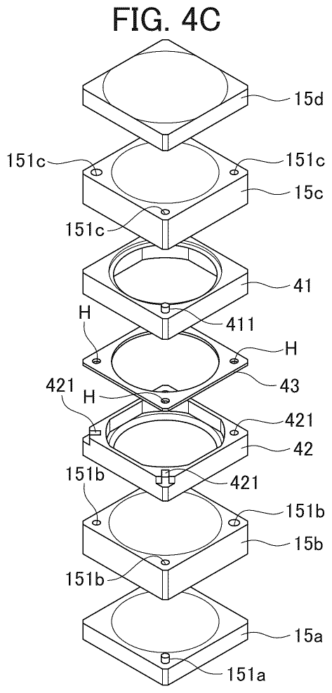

The retaining member 14 is a member arranged in the cavity inside the plunger 13 and, as described above, is configured with the combination of the spacers 41 and 42 that are made of resin and have light-blocking characteristics and the diaphragm film 43. The retaining member 14 retains the lenses 15a to 15d. Specifically, as illustrated in FIGS. 2 and 4C, for example, on the top face of the spacer 41, ribs 411 are provided in two locations. Further, on the bottom face of the lens 15c, rib receptacles 152c are provided in two locations, so that the ribs 411 on the spacer 41 can be fitted therein respectively. In addition, on the bottom face of the lens 15d, ribs 151d are provided in four locations. Further, on the top face of the lens 15c, rib receptacles 151c are provided in four locations so that the ribs 151d on the lens 15d can be fitted therein, respectively. With this configuration, the spacer 41 retains the two lenses (the lenses 15c and arranged adjacent to the diffuser plate 12.

On the bottom face of the spacer 41, ribs 412 are provided in four locations. Further, on the top face of the spacer 42, rib receptacles 421 are provided in four locations, so that the ribs 412 on the spacer 41 can be fitted therein respectively. In addition, on the bottom face of the spacer 42, ribs 422 are provided in four locations. Further, on the top face of the lens 15b, rib receptacles 151b are provided in four locations so that the ribs 422 on the spacer 42 can be fitted therein, respectively. In addition, on the top face of the lens 15a, ribs 151a are provided in two locations. Further, on the bottom face of the lens 15b, rib receptacles 152b are provided in two locations so that the ribs 151a on the lens 15a can be fitted therein, respectively. With this configuration, the spacer 42 retains the two lenses (the lenses 15a and 15b) arranged adjacent to the display D.

Further, the diaphragm film 43 is arranged between the spacer 41 and the spacer 42. Specifically, provided in the vicinity of the four corners, respectively, of the diaphragm film 43 are holes H to be penetrated by the ribs 412 on the spacer 41. The ribs 412 having penetrated the holes H are fitted into the rib receptacles 421 on the spacer 42. As a result, the diaphragm film 43 is sandwiched between the spacer 41 and the spacer 42. As described above, because the diaphragm film 43 is provided, it is possible to address changes in depth of field (focus range), without using a lens barrel.

Together with the lenses 15a to 15d, the retaining member 14 functions as a part of the lens unit 44 such that the position and the orientation of each of the lenses 15a to 15d are fixed relative to the display D. The number of lenses included in the lens unit 44 is not limited in particular, as long as a plurality of lenses can be incorporated. For example, three lenses may be included. Alternatively, two lenses may be incorporated, by including a first lens that integrates the lenses 15a and 15b, and a second lens that integrates the lenses 15c and 15d. The retaining member 14 may also be integrated with the housing 16.

### (Lens)

The lenses 15a to 15d are lenses that function as a part of the lens unit 44 and that refract and condense the light ray group of the video outputted from the display D as an image formed on the diffuser plate 12. Both the lenses 15a and 15d are each constituted by a planoconvex lens having a convex surface and a substantially flat surface. Of these lenses, the lens 15a is a planoconvex lens having a convex surface toward the display D and a substantially flat surface toward the button 11. The lens 15d is a planoconvex lens having a convex surface toward the button 11 and a substantially flat surface toward the display D. Further, both the lenses 15b and 15c are each constituted by a concave meniscus lens having a convex surface and a concave surface. Of these lenses, the lens 15b is a concave meniscus lens having a concave surface toward the display D and a convex surface toward the button 11. The lens 15c is a concave meniscus lens having a convex surface toward the button 11 and a convex surface toward the display D. The retaining member 14 retains and arranges the lenses 15b and 15c such that the convex surfaces face each other. Specifically, the lenses 15b and 15c are retained as a result of the ribs 422 on the spacer 42 and the ribs 411 on the spacer 41 being fitted, respectively, into the rib receptacles 151b and 152c that are provided for the lenses 15b and 15c, respectively. Further, in the lenses 15a to 15d and the retaining member 14, the exterior dimensions in the direction orthogonal to the direction of the depressing operation are equal or substantially equal. As a result, as illustrated in FIG. 4A and FIG. 4B, for example, the lens unit 44 has appearance of an integral shape having flat lateral faces.

Because the retaining member 14 and the lenses 15a to 15d constituting the lens unit 44 each have the configuration as described above, it is possible to condense and diffuse the inputted light ray group, without using a lens barrel made of metal that serves as a passage for the light ray group. In other words, the light ray group inputted from the display D is condensed by the lenses 15a and 15b included in the lens unit 44 and arranged below the retaining member 14. Further, when the retaining member 14 limits the light, the light ray group is diffused by the lenses 15c and 15d arranged above the retaining member 14. In other words, in the present embodiment, it is possible to give the person who performs the depressing operation a clear operational feeling, as a result of the light ray group being condensed and diffused with the use of the curved surfaces (the convex surface and the concave surface) of the lenses 15a to 15d, the spacers 41 and 42 having the light blocking characteristics and the light ray group being limited with the use of the diaphragm film 43. In addition, it is possible to display the image outputted from the display with further increased sharpness, accuracy, and brightness, as compared to conventional examples.

### (Housing)

The housing 16 is a box-shaped housing having a storage space inside, which can store a multitude of members that constitute the pushbutton switch 1. Specifically, the housing 16 houses the plunger 13, the retaining member 14, the lenses 15a to 15d, the coil spring 17, and the contact point 18. Although the shape of the housing 16 is not limited in particular, in the present embodiment, the shape is a substantially square pole shape having a cavity inside, as illustrated in FIG. 1 and FIG. 2.

### (Coil Spring)

The coil spring 17 is a linear coil spring having one end connected to the bottom of the plunger 13 and the other end connected to the membrane sheet 31 or the contact point 18. The coil spring 17 contracts in the direction of a depressing operation on the button 11, in conjunction with an operation of the plunger 13 that slides downward by the depressing operation. When the depressing operation on the button 11 is released, the coil spring 17 elastically deforms and upwardly pushes back the plunger 13 connected to the one end. As a result, the button 11, the diffuser plate 12, and the plunger 13, which were positioned below by the depressing operation, return to the position before performing the depressing operation. The aspect of the coil spring 17 is not limited in particular and may at least include a function of returning the members to the position before performing a depressing operation, when the depressing operation on the buttons 11 is released.

### (Contact Point)

The contact point 18 is a contact mechanism that switches between a blocked state and an energized state in conjunction with a depressing operation on the button 11. The contact point 18 maintains the blocked state before performing a depressing operation on the button 11, and switches to the energized state upon performing a depressing operation. Upon performing a further depressing operation, the contact point 18 switches from the energized state to the blocked state. More specifically, the contact point 18 switches between the blocked state and the energized state each time a depressing operation on the pushbutton switch 1 is performed. An upper end of the contact point 18 is connected to the end of the coil spring 17.

### (Fixing Plate)

The fixing plate 19 is a member for fixing the pushbutton switch 1 to the mounting panel P and is arranged at four corners of the lower portion of the housing 16.

With the configuration as described above, the pushbutton switch 1 can display the video, on the top panel (diffuser plate 12) of the button 11 in the standby position before performing the depressing operation, with further increased sharpness, accuracy, and brightness, as compared to conventional examples, the video being outputted from the display D positioned at a sufficient distance from the top panel (diffuser plate 12). In addition, an operational stroke is ensured because there is a sufficient space between the button 11 in the standby position before the depressing operation and the lens 15d. As a result, a person who performs a depressing operation can obtain a clear operational feeling. In this situation, the specific distance of the stroke is not limited in particular; however, it is desirable to ensure a distance of at least 1.8 mm or more, in order to allow a person who performs a depressing operation to obtain a clear operational feeling. The distance of the stroke of the pushbutton switch 1 of the present embodiment is 3 mm or more.

In addition, with the configuration as described above, the pushbutton switch 1 is able to improve design margins for the lenses. It is also possible to shorten the total length of the lenses. Further, the lens barrel used in the conventional pushbutton switch is made of metal. In contrast, the spacers 41 and 42 of the pushbutton switch 1 in the present embodiment are made of resin. Consequently, it is also possible to reduce manufacturing costs. In addition, because it is possible to reduce the number of component parts being used, it is possible to simplify the process of changing magnifications by changing the combination of the lenses. Furthermore, as illustrated in FIG. 4A to FIG. 4C, as a result of having the ribs fitted in the rib receptacles, the lens unit 44 is formed as an integral body having no sideway misalignment. Thus, fixing (retaining) the lenses in the housing 16 is facilitated.

The pushbutton switch 1 according to the present embodiment can be fixed, side by side, onto the mounting panel P by using the membrane sheet 31 described above. Specifically, for example, three pushbutton switches 1 may be coupled to form a single unit using a single membrane sheet 31, and sequentially arranged and fixed onto the mounting panel P. In this situation, the specific method of fixing the pushbutton switches 1 to the mounting panel P is not limited in particular; however, for example, the mounting panel P may be provided with holes, so that the fixing plates 19 of the pushbutton switches 1 are inserted and fixed therein. As described above, the plurality of pushbutton switches 1 fixed on the mounting panel P may be arranged and fixed on the display D, thereby making it possible to structure a prescribed input device. On the plurality of pushbutton switches 1 orderly arranged on the surface of input device to which the pushbutton switches 1 are applied, it is possible to display the video outputted from the display D with further increased sharpness, accuracy, and brightness, as compared to conventional examples.

An embodiment of the present invention has been described above; however, the present invention is not limited to the above-described embodiments, and modifications, improvements, etc. within the scope that can achieve the object of the present invention are included in the present invention. Various modifications may be made without departing from the spirit of the present invention.

For example, in the embodiment described above, the shape of the lenses 15b and 15c is a concave meniscus lens shape having a projection part and a recessed part, and the shape of the lenses 15a and 15d is a planoconvex lens shape having a projection part and a substantially flat portion. However, the above is merely an example. Lenses of an aspect that can achieve the object of the present invention may be used. For example, a biconvex lens, a convex meniscus lens, a planoconcave lens, a biconcave lens, etc. may be employed.

In summary, the pushbutton switch to which the present invention is applied may be configured as follows and can take various embodiments. Specifically, a pushbutton switch to which the present invention is applied (e.g., pushbutton switch 1 of FIG. 1 to FIG. 3C) includes:
a transparent or substantially transparent button (e.g., button 11 and the diffuser plate 12 of FIG. 1 to FIG. 3C) that receives a depressing operation and is arranged above an external display (e.g., display D of FIG. 1 to FIG. 3C);
a plurality of lenses (e.g., lenses 15a to 15d of FIG. 1 to FIG. 4C) arranged between the button and the external display, the plurality of lenses projecting an image outputted from the external display as focused on a top panel (e.g., diffuser plate 12 of FIG. 1 to FIG. 3C) of the button in a standby position before performing the depressing operation; and
a retaining member (e.g., retaining member 14 of FIG. 2) that retains the plurality of lenses such that a position and orientation of each of the plurality of lenses are fixed relative to the external display. The retaining member
is configured with a combination including a first retaining member (e.g., spacer 41 of FIG. 2) that has a first fitted part (e.g., ribs 411 of FIG. 2) to be fitted with a first projection part or a first recessed part (e.g., rib receptacles 152c of FIG. 2) provided in a vicinity of an edge part of one of the plurality of lenses arranged adjacent to the top panel; a second retaining member that has a second fitted part (e.g., ribs 422 of FIG. 2) to be fitted with a second projection part or a second recessed part (e.g., rib receptacles 151b of FIG. 2) provided in a vicinity of an edge part of one of the plurality of lenses arranged adjacent to the external display; and a diaphragm member (e.g., diaphragm film 43 of FIG. 2) sandwiched between the first retaining member and the second retaining member (e.g., spacer 42 of FIG. 2).

With this configuration, in the above embodiment, for example, it is possible to refract and condense the light ray group of the video outputted from the display D as an image formed on the diffuser plate 12, without using a lens barrel. As a result, it is possible to project the video outputted from the display D on the diffuser plate 12 that is transparent or substantially transparent, with further increased sharpness, accuracy, and brightness, as compared to conventional examples.

Furthermore, in the plurality of lenses and the retaining member, exterior dimensions in a direction orthogonal to a direction of the depressing operation may be equal or substantially equal, and

a lens unit (e.g., lens unit 44 of FIG. 4A to FIG. 4C) configured with a combination including the plurality of lenses and the retaining member may be integrally retained by the fitting, without using other members (e.g., lens barrel of FIG. 5).

Consequently, while the exterior dimensions of the plurality of lenses and the retaining member in the direction orthogonal to the direction of the depressing operation are equal or substantially equal, it is possible to integrally retain the lens unit configured with the combination including the plurality of lenses and the retaining member, without using other members. As a result, it is possible to increase the luminous flux diameter, to improve design margins for the lenses, to shorten the total length of the lenses, to reduce costs, to address changes in the depth of field (the focus range), to simplify the process of changing magnifications by changing the combination of the lenses, to facilitate fixing the lenses, and the like.

Further, the first projection part or the first recessed part may be provided on a surface adjacent to the external display in the vicinity of the edge part of the one of the lenses arranged adjacent to the top panel,
the first fitted part may be provided on a surface adjacent to the top panel in a vicinity of an edge part of the first retaining member,
the second projection part or the second recessed part may be provided on a surface adjacent to the top panel in the vicinity of the edge part of the one of the lenses arranged adjacent to the external display, and
the second fitted part may be provided on a surface adjacent to the external display in a vicinity of an edge part of the second retaining member.

With this configuration, in the above embodiment, for example, it is possible to refract and condense the light ray group of the video outputted from the display D as an image formed on the diffuser plate 12, without using a lens barrel. As a result, it is possible to project the video outputted from the display D on the diffuser plate 12 that is transparent or substantially transparent, with further increased sharpness, accuracy, and brightness, as compared to conventional examples.

### EXPLANATION OF REFERENCE NUMERALS

1: pushbutton switch; 11: button; 12: diffuser plate; 13: plunger; 14: retaining member; 15a, 15b, 15c, 15d: lens; 16: housing; 17: coil spring; 18: contact point; 19: fixing plate; 41, 42: spacer; 43: diaphragm film; 151a, 151d, 411, 412, 422: rib; 151b, 152b, 151c, 152c, 421: rib receptacle; 44: lens unit; P: mounting panel; D: display; H: hole

1. A pushbutton switch, comprising:
a transparent or substantially transparent button that receives a depressing operation and is arranged above an external display;
a plurality of lenses arranged between the button and the external display, the plurality of lenses projecting an image outputted from the external display as focused on a top panel of the button in a standby position before performing the depressing operation; and
a retaining member that retains the plurality of lenses such that a position and orientation of each of the plurality of lenses are fixed relative to the external display, wherein
the retaining member
is configured with a combination including a first retaining member that has a first fitted part to be fitted with a first projection part or a first recessed part provided in a vicinity of an edge part of one of the plurality of lenses arranged adjacent to the top panel; a second retaining member that has a second fitted part to be fitted with a second projection part or a second recessed part provided in a vicinity of an edge part of one of the plurality of lenses arranged adjacent to the external display; and a diaphragm member sandwiched and held between the first retaining member and the second retaining member.

2. The pushbutton switch according to claim 1, wherein
in the plurality of lenses and the retaining member, exterior dimensions in a direction orthogonal to a direction of the depressing operation are equal or substantially equal, and
a lens unit configured with a combination including the plurality of lenses and the retaining member is integrally retained by the fitting, without using other members.

3. The pushbutton switch according to claim 1, wherein
the first projection part or the first recessed part is provided on a surface adjacent to the external display in the vicinity of the edge part of the one of the lenses arranged adjacent to the top panel,
the first fitted part is provided on a surface adjacent to the top panel in a vicinity of an edge part of the first retaining member,
the second projection part or the second recessed part is provided on a surface adjacent to the top panel in the vicinity of the edge part of the one of the lenses arranged adjacent to the external display, and
the second fitted part is provided on a surface adjacent to the external display in a vicinity of an edge part of the second retaining member.
